(19) United States
(12) Patent Application Publication
(10) Pub. No.: US 2006/0109940 A1
(43) Pub. Date: May 25, 2006

(54) Timing bias compensation for a data receiver with decision-feedback equalizer

(76) Inventors: Troy Beukema, Briarcliff Manor, NY (US); Benjamin Danford Parker, Peekskill, NY (US); Karl David Selander, Hopewell Junction, NY (US); Michael A. Sorna, Hopewell Junction, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 10/994,742

(22) Filed: Nov. 22, 2004

(51) Int. Cl. H04L 7/00; H04B 1/10

(52) U.S. Cl. 375/350; 375/355

(57) ABSTRACT

A phase adjustment apparatus and method adjusts phase or timing bias of a sample clock in a data receiver system by determining a time adjustment value as a function of equalizer feedback. The time adjustment value is then applied to a device capable of adjusting a timing bias of a sample clock.

### BACKGROUND

1. Technical Field

The present invention relates to data receivers, and more particularly to an apparatus, system and method, which provides an improved timing bias compensation circuit for receivers with decision feedback equalization.

2. Description of the Related Art

Modern high-speed serial input/output (I/O) interfaces increasingly rely on the addition of receiver equalization systems to compensate channel distortion effects arising from such impairments as bandwidth limitation and line/termination impedance mismatches. As data rates for serial interfaces begin to exceed 3 to 4 Gb/s, bandwidth limitation due to conductor skin-effect loss and board material dielectric loss, and impedance mismatches due to board through-vias, non-ideal packaging, and integrated circuit parasitics can add significant levels of inter-symbol interference (ISI) to a high speed data stream.

One well-known approach to combat the ISI distortion problem makes use of a non-linear equalization structure in a data receiver referred to as decision-feedback equalization (DFE). The DFE subtracts weighted estimates of previously detected data bits/symbols from a current data bit/symbol to remove inter-symbol interference added to the current data bit/symbol in the channel.

Referring to FIG. 1, a block diagram of a typical DFE receiver structure 10 is shown. In this example, a received data signal (Data signal) is buffered with a linear amplifier 12, which connects to a linear summer 14. The linear summer 14 adds scaled values from the two previously decoded data bits to the received signal to reduce ISI contributions in the channel from these data bit positions. Delay elements 16 may be employed to adjust the signal. A first feedback tap 18 is scaled by weight “h1” and a second tap 20 is scaled by weight “h2”. It should be noted that capital letters D and E shown throughout the FIGS. represent data (D) and edge (E, E2, etc.) related signals.

Most practical DFE systems include additional complexity to determine the feedback tap weights adaptively. The number of DFE taps is selected according to the channel characteristics and can vary from 1 to 8 feedback taps or more.

All DFE systems do not use the first feedback tap “h1” 18, but use of this tap position can provide significant advantages to a receiver system since this tap position enables the equalizer to improve performance for reception of an alternating 1010 . . . sequence (in an example binary receiver). The alternating 1010 . . . sequence produces a high frequency signal on the line, which is normally highly attenuated due to channel characteristics, which roll off at high frequency, resulting in degraded data recovery. A DFE system employing a first-feedback tap weight can significantly improve receiver performance since the 1010 or other data patterns including a large number of transitions can be equalized without requiring the waveform to be pre-distorted, or pre-emphasized (e.g., high-frequency sections of the signal amplified) at the transmitter side of the link as shown in FIG. 2.

Referring to FIG. 2, a transmitter 22 and receiver 24 are shown for a system 30. Typical transmitter pre-emphasis by an amplifier 26 and filter 28 reduces low-frequency gain with respect to high frequency gain, which in turn reduces the achievable signal level at the receiver end of the link. In addition, transmitter pre-emphasis amplifies the signal in the high frequency range where the impedance match of a channel 32 degrades, increasing signal distortion prior to sampling the data value in the receiver 24.

By using a non- or minimally pre-emphasized transmission coupled with a decision-feedback equalizer 34 with a first-feedback tap weight h1, the signal can be sent down the line with higher low-frequency signal level while avoiding signal amplification in the high frequency range;

Referring to FIG. 3, in an asynchronous data receiver system 40, a phase-locked loop (PLL) 42 is commonly used to create a reference clock, which is aligned in phase (or edge transition times) with a received data waveform. Once the receiver's phase-locked loop acquires the timing point of the received data waveform transitions or edges, the timing point to sample the data is set at a fixed offset (½ symbol time, or 180 degrees in phase) from the edge timing reference. This is illustrated in FIG. 3A, which shows a conventional analog-PLL based data receiver 40.

The PLL block 42 includes an early-late integrator, which drives a voltage-controlled oscillator to lock to the transitions of the received data signal. The resulting edge clock, which is aligned to the edge positions of the received signal, is shifted in phase in block 44 by 180 degrees (or ½ data symbol time) to produce a clock for sampling the data values midway within the data symbol time interval. The PLL/data latch combination is sometimes called a Clock and Data Recovery (CDR) system.

A refinement of an analog-PLL based CDR 40 is the digital-PLL based CDR 50 shown in FIG. 3B. The digital PLL based CDR 50 includes one analog PLL 42 which produces a fixed frequency clock output. In contrast with the analog CDR approach, the PLL clock is not explicitly locked to the received data. Instead, the PLL output drives two mixers 54, or rotators, which have the ability to rotate the PLL output clock from 0 to 360 degrees by adjusting mixer analog control levels I and Q (in-phase and quadrature).

The IQ phase setting, or rotator phase-shift value is determined using a Digital PLL algorithm which processes the received Data/Edge signals to create a sequence of rotator values which keep the rotated edge clock aligned to the transitions of the received data signal. The rotated edge clock is shifted 180 degrees 56 by independently adjusting the IQ values for the data clock such that they are 180 degrees out of phase with the edge clock. Digital to analog converter D/A are employed.

### SUMMARY

Problems can arise with conventional CDR systems (such as those diagrammed in FIGS. 3A and 3B) when a DFE is used with regard to optimum sampling time of the received data waveform. For example, if the DFE makes use of feedback from the data symbol received immediately prior to a currently received data symbol (e.g., the first DFE feedback tap), timing bias arises between a sampling instant determined from the center between the mean received signal crossover points of the received signal and the center between the mean received signal crossover points summed with the DFE feedback. This timing bias degrades the receiver jitter tolerance, or ability of the receiver to correctly decode data given varying time drift on the transmitter/receiver clocks, since a transmit or receive clock can jitter less on one side of the sampling point than on the other side of the sampling point before data decode becomes unreliable.

A phase adjustment apparatus and method adjusts phase of a sample clock in a data receiver system by determining a time adjustment value as a function of equalizer feedback. The time adjustment value is applied to a device capable of adjusting a timing bias of a sample clock.

A phase adjustment apparatus and method adjusts a sample clock in a data receiver system as a function of a feedback weight of an equalizer. A predicted phase adjustment module and/or a timing bias module (which employs measurement/analysis and comparison of signals) determines a time adjustment value as a function of a equalizer feedback weight, and a device capable of adjusting the phase of a sample clock in accordance with the time adjustment value is adjusted.

The exemplary embodiments of present disclosure will address a way to determine and apply an adjustable data clock timing offset to compensate for the DFE bias effect to improve jitter tolerance and lower bit-error rate of a data transmission system which employs decision-feedback equalization in the data detection path.

A detailed description of the timing bias effect will be described, which impacts jitter tolerance/bit-error rate of a serial link when a decision-feedback equalizer is used as part of the receiver system design.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing a data receiver using a decision-feedback equalizer (DFE) in accordance with the prior art;

FIG. 2 is a block diagram showing a data transmission system with transmitter pre-emphasis in accordance with the prior art;

FIGS. 3A and 3B are block diagrams showing data receivers with clock and data recovery phase locked loops in accordance with the prior art;

FIGS. 4A and 4B are diagrams showing leading and trailing edge biases, respectively, for a first feedback tapped system in accordance with the prior art;

FIG. 5 is a diagram showing timing bias offset prediction in accordance with exemplary embodiments;

FIG. 6 is a block diagram showing a receiver system having a DFE timing bias compensation module in accordance with one illustrative embodiment;

FIG. 7 is a block diagram showing a receiver system having a DFE timing bias compensation module with a digital phase lock loop in accordance with one illustrative embodiment; and

FIG. 8 is a block diagram showing a receiver system having another DFE timing bias compensation module using measured values in accordance with another illustrative embodiment.

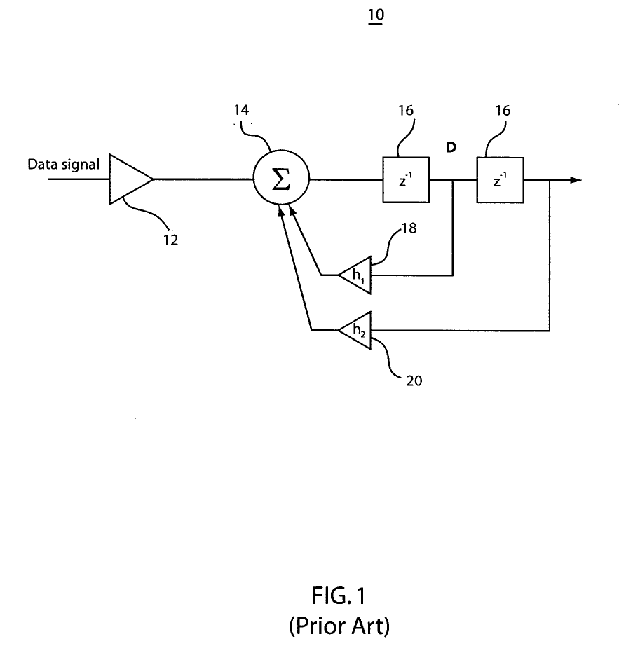

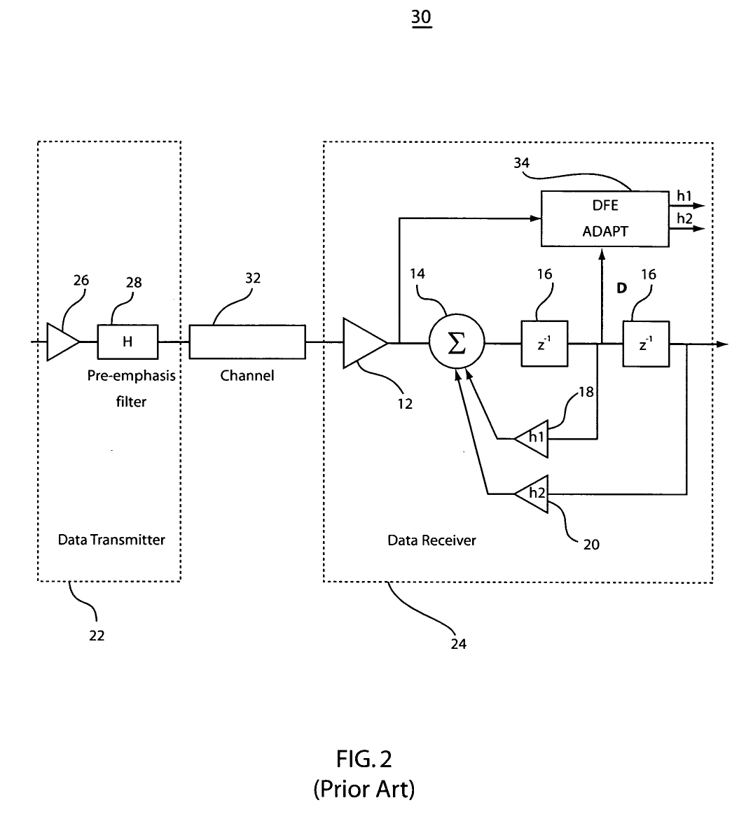

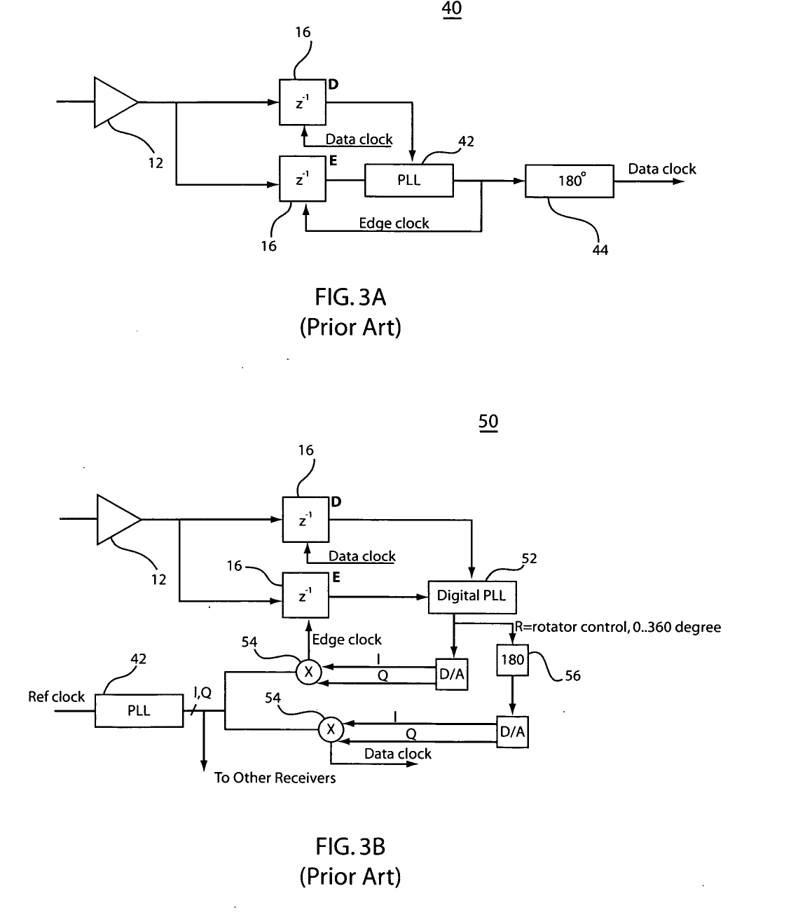

### DETAILED DESCRIPTION OF PROFFERED EMBODIMENTS

A method and apparatus for providing a timing bias compensation for a data receiver system, which employs a decision-feedback equalizer (DFE) are described. Exemplary embodiments make use of a linear approximation formula based on a normalized first decision-feedback tap weight. The formula provides a timing bias estimate, which is employed to adjust the phase relationship between a data clock and an edge clock to advance or delay the data sampling point of a receiver system. Application of the timing bias compensation provides a data sampling time closer to a center of a DFE corrected eye diagram, improving jitter tolerance of a data receiver system.

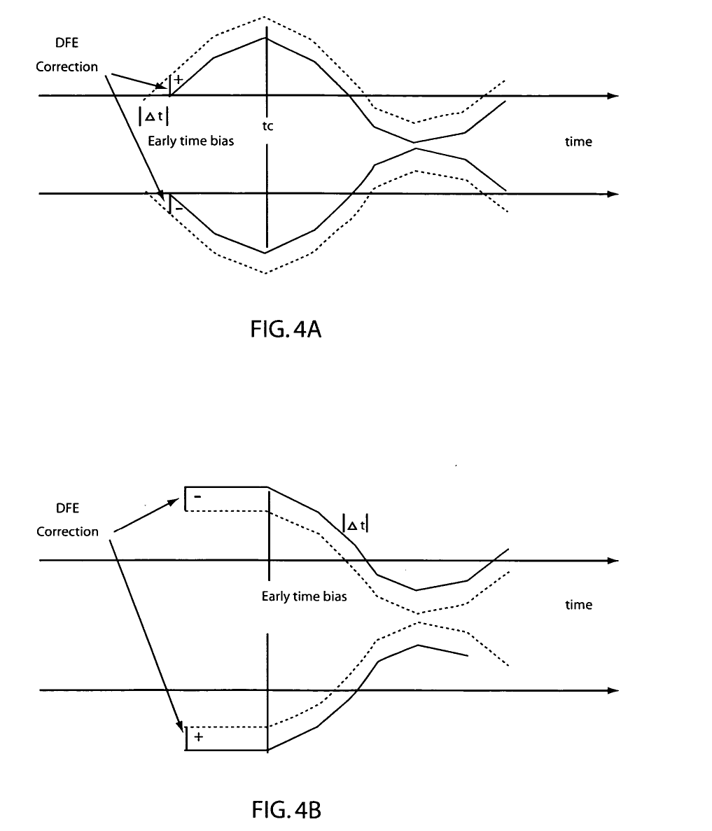

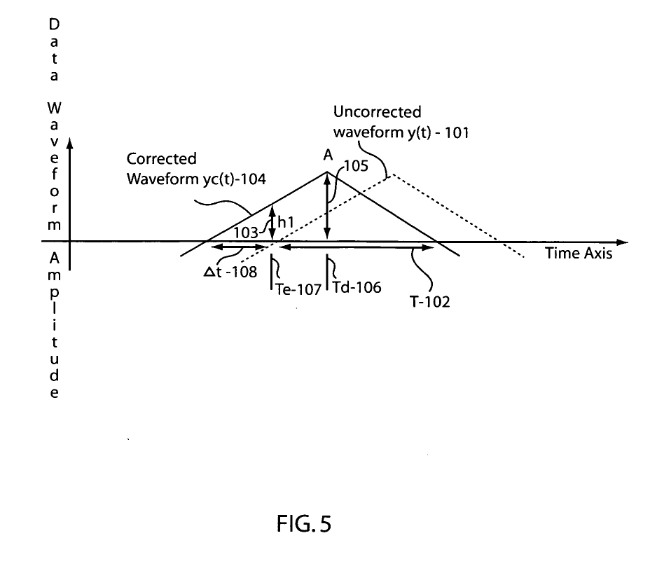

Exemplary embodiments provide a method for realizing a time-corrected sampling point for a received waveform, which has been conditioned with decision-feedback equalization (DFE) in a data receiver system. A general embodiment provides a method for determination of a time-correction value for a data sampling point of a received waveform and application of the time-correction value to a data sampling apparatus. A general form of determination of a time correction value is described here as any method or apparatus capable of resolving both the necessary polarity (time advance or time retard) and magnitude (amount of time shift) arising from application of a equalization compensation to a received data signal which results in a sampling timing bias as described here (see e.g., FIGS. 4A and B).

Referring to FIGS. 4A and 4B, the timing bias effect is illustrated. For simplicity, the timing-bias effect is explained using a two-level (binary) waveform. Two timing bias cases can occur depending on the sign of the DFE feedback, which can be positive or negative for a binary signal transmission. In the most typical case (i.e., a lowpass channel), the DFE feedback sign will be negative (at the first feedback bit/symbol position), meaning the negative of the value of the prior detected data symbol is added to the received waveform being sampled to cancel the effect of ISI addition in the channel. When this is the case, a previous bit with a sign value “−1” adds a positive offset to a received waveform, and a previous bit with a sign value of “+1” adds a negative offset to a received waveform.

Therefore, when the received data transitions from a negative to positive symbol, the DFE corrected waveform will be biased with a positive level, and when the received data transitions from a positive to negative symbol, the DFE corrected waveform is biased with a negative level. This behavior is shown in the diagram labeled “Early DFE timing bias” (leading edge bias with 01, 10 sequences) in FIG. 4A.

As can be seen in FIG. 4A, the net effect of the DFE feedback is to shift the timing crossover point of the DFE corrected waveform earlier in time with respect to the transition from (− to +) or (− to +) of the uncorrected waveform value.

A similar timing bias at the falling edge (trailing edge bias) of received 110 or 001 sequences also occurs due to the DFE feedback, as illustrated in FIG. 4B. Since the first data bit is the same sign as the second data bit in these three-bit transmission sequences, there is no crossover point at the beginning of the second bit interval. However, when the bit following the second bit changes to a sign opposite the second bit, a crossover will occur at the trailing edge of the second bit time interval. The time of this crossover is biased early by the DFE feedback as can be seen in FIG. 4B. In essence, the DFE feedback forces the waveform diagram to cross zero earlier at the falling edge of a bit interval than it would with no DFE feedback. Because the falling edge timing bias is in the same direction (early, in this example) as the leading edge bias (which occurs with 01, 10 sequences), the net result of the DFE feedback is to bias the corrected waveform earlier in time with respect to the non-corrected received waveform.

The timing bias effect only occurs as a result of correlation between the first feedback tap position and the current received bit interval when a data transition takes place. More specifically, to cause a waveform crossover, the data must toggle from 0-1 or 1-0 from one bit time to a next bit time. For DFE feedback positions further away than one symbol time, no systematic timing bias arises since the value of the data bit at the DFE feedback position further removed than the first feedback tap position is not correlated with the generation of a waveform crossover point for the data bit interval during which the feedback is being applied.

Hereinafter, example waveform measurement-based timing bias determination methods will be given as well as novel and efficient timing offset prediction formulas which make use of information already present in a data equalization system to minimize extra system complexity necessary to realize a timing bias compensation in a decision-feedback equalizer based data receiver system.

It is understood that the described invention is not limited to embodiments based on illustrative examples or preferred embodiments presented here, but pertains to the general use of a method which detects a timing bias using any combination of waveform analysis or timing bias prediction and as a result of this timing bias measurement or prediction applies a corresponding timing correction to a data sampling apparatus.

It should be understood that the elements shown in FIGS. may be implemented in various forms of hardware, software or combinations thereof. Preferably, these elements are implemented in hardware, although software may be employed on one or more appropriately programmed general-purpose digital computers having a processor and memory and input/output interfaces.

Exemplary embodiments, illustratively shown in the FIGS., provide a method and apparatus for realizing a time-corrected sampling point for a received waveform, which has been conditioned with decision-feedback equalization (DFE) in a data receiver system. Preferred embodiments make use of a timing offset prediction formula, which takes as an argument a normalized DFE feedback weight which in a preferred embodiment is derived from a mean received signal level at a data sampling time and a level of a first DFE feedback tap value found using an adaptive equalization algorithm or method.

The mean signal level and feedback tap weight values are combined to produce a normalized first DFE feedback tap weight, which is used to compute a predicted time offset or time bias. The predicted time bias may be applied to a device capable of adjusting the time delay of a received data sampling instant with respect to a received waveform edge sampling instant. The method reduces the timing bias arising from summation of a first DFE feedback tap value to a received data waveform.

Referring to FIG. 5, the following description for the derivation of an appropriate timing offset prediction formula is described with reference to FIG. 5. FIG. 5 diagrams an example of a received uncorrected data waveform 101, which has a mean duration 102 of T seconds from leading to falling edges. Time interval T is referred to as the symbol period of the data transmission, and represents one bit period in a binary coded system. Time interval T may also be referred to as a UI (unit-interval) in the art.

In a decision-feedback equalized system with first-feedback tap hi, value hi 103 is added to received uncorrected waveform 101 to produce corrected waveform 104, which is defined to have a mean vertical amplitude “A” 105 at a mean data sampling time Td 106. Uncorrected waveform 101 crosses the time axis at a time Te 107 while corrected waveform 104 crosses the time axis at a time Δt 108 earlier than Te 107 due to the DFE timing bias effect.

To estimate, or predict, the timing bias At 108 as a function of DFE feedback weight hi 103, an assumption of the slope of the received waveform 101 in its crossover range can be made. For a received signal which is band-limited with a filter with bandwidth 1/(2T) Hz, the received waveform given an alternating “1010 . . . ” transmission sequence is approximately sinusoidal and described by a function:
y(t)=A sin(π/T*t) (1)

This function is differentiated to produce
y′(t)=π/T A cos(π/t) (2)
which has a maximum value of m=(π/T)A at the waveform crossover point (t=0), where m is the defined as the slope at the data waveform crossover point.

A second assumption for the slope of the waveform at the crossover point can be found by assuming the received waveform transitions from its crossover point to the mean value “A” linearly in a time interval of T/2 seconds. In this case, the waveform can be described by

$$y ( t ) = A / ( \frac{T}{2} ⋆ t ) = 2 A / ( T ⋆ t ) \qquad ( 3 )$$

which is differentiated to produce
y′(t)=2A/T (4)

Formulas (2) and (4) provide an estimated bound for the received waveform slope at the crossover point from a minimum of m=2 A/T (for slow transitions) to a maximum of m=π*A/T (for fast transitions, for a signal bandlimited to a frequency of 1/(2T) Hz).

Time bias Δt can be estimated by using a linear extrapolation of the waveform crossover slope “m”. In this case, corrected waveform yc(t) can be described by
yc(t)=m*t (5)
in the waveform crossover region where time origin t=0 is arbitrarily defined as the waveform crossover point. Solving (5) for t as a function of waveform value yc(t) results in:
t=yc(t)/m (6)

Time bias Δt can now be found as a function of DFE correction value h1 by setting yc(t)=h1 and substituting values for the crossover slope m of the received waveform. Using m=π/T*A produces
Δt=h1/(π/T*A)=h1/A/π*T (7)
while m=2/T*A produces
Δt=h1/(2/T*A)=h1/A/2*T (8)

Equations (7) and (8) can be re-written to find the phase-shift normalized to a unit interval (UI=T) by dividing each side of the equation by T:
Δt/T=h1/A/π (9)
and
Δt/T=h1/A/2 (10)

If one UI is defined as 360 degrees, or 2*π radians of phase shift, the normalized time shifts computed in (9) and (10) can be translated to units of phase shift by multiplying each side of the equations by the number of phase shift units corresponding to one full cycle of phase (e.g., 360 degrees or 2*π radians, etc.). If P is defined as the number of phase shift units corresponding to one full cycle of phase (which in turn corresponds to one full bit period), equations (9) and (10) can be converted to phase representation to find the time biased expressed as a phase shift f:
f=h1/A*(P/π) (11)
and
f=h1/A*(P/2) (12)

As a further approximation to the time bias estimate, an average phase shift can be computed by using the arithmetic mean of the high and low crossover slope values estimated in (11) and (12):
f_{AV}=h1/A*(P/2.444) (13)

Expressed in degrees, P=360 and formula (13) results in
f_{AV}=h1/A*148 (14)

These equations are understood to be approximations, but useful to provide practical estimates for the time bias. To increase flexibility of the timing bias computation for application in specific channels, which may have waveform crossover slopes significantly different from the average computed in (13), a programmable scaling factor or correction factor “k” may be applied to (13):
f_{AV}=h1/A*(P/2.444)*k (15)

In summary, phase prediction formula (15) computes a predicted phase offset due to a normalized first DFE feedback tap weight h1/A. The predicted phase offset can be computed by a linear multiplication of the normalized DFE feedback weight h1/A with a constant.

A scaling factor may be applied to the resulting phase shift estimate to permit refinement of the time bias prediction value on an application-specific basis.

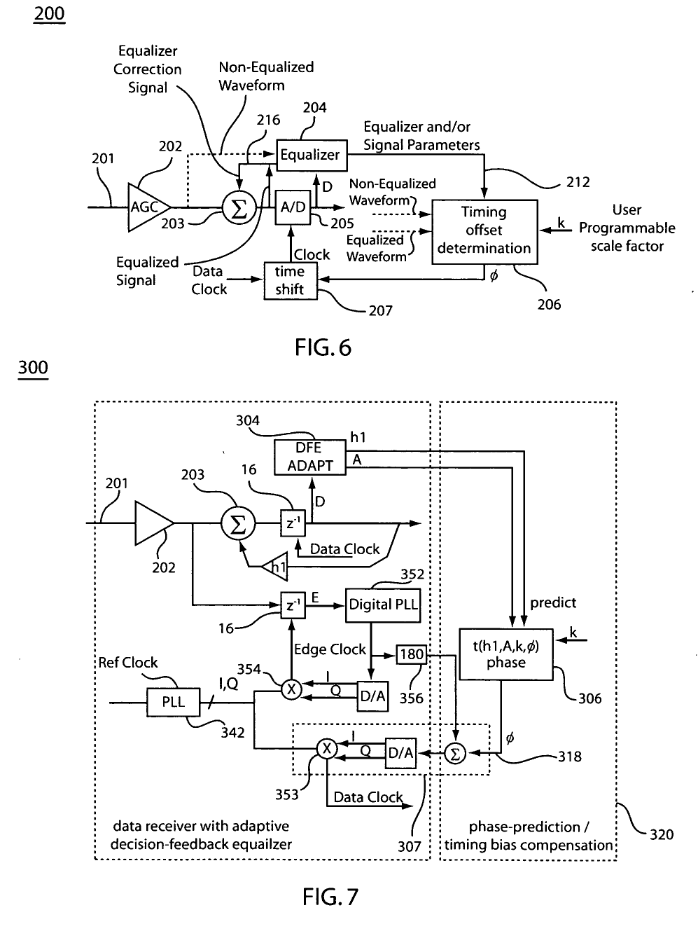

Block diagrams of illustrative embodiments of a high-speed data receiver system are shown in FIGS. 6, 7 and 8.

Referring to FIG. 6, a timing bias compensation circuit 200 employs a variable time advanced data sampling with a DFE receiver system. This may include a method, which uses time advanced data sampling with a DFE, where the time advance is determined by either a predicted phase advance (covering a fixed or variable time advance) or a phase advance determined from measurement/analysis of the received waveform or a combination thereof. As an example, with respect to the timing bias in the embodiment, a module 206 is included and connected to an equalizer 204. Module 206 determines a timing bias of a DFE crossover with respect to a time reference. The time reference may be established, e.g., by an edge detection by direct measurement or analysis of the received waveform, or by a reference clock. Other configurations may also be employed.

It should be understood that implementation of illustrative embodiments as described herein should not be construed as limited to the receiver architecture shown in FIGS. 6, 7 and 8, but may be applied to any receiver system which sums a first DFE feedback value to a received waveform and is capable of adjusting a data sampling time as a function of a DFE feedback value as shown in FIG. 6.

The data receiver shown in FIG. 6 accepts as input a received signal 201, which in this example illustratively represents a binary-encoded (2-level) data stream in high-speed serial link applications. To simplify explanation of the system operation, a decision-feedback equalization system employing only one feedback tap 216 is shown, but it is understood that a receiver may use a greater number of feedback taps than 1 (a range of 3 to 8 is preferable).

However, feedback taps further delayed than 1 bit from the current bit being received are less relevant to the embodiments described herein because they do not add a systematic timing bias to the received waveform, as described above.

In operation, a received signal 201 is scaled by an automatic gain-control (AGC) amplifier 202 to produce a suitable signal level to drive summing device 203, which linearly sums an appropriate feedback value determined by equalizer adaptation process 204 to the received waveform. The linear sum output from summing device 202 is sampled by A/D converter device 205 to produce digital information from which estimates of the transmitted data are derived.

Estimates of the transmitted data along with the received signal value are sent to equalizer adaptation process 204 to refine the equalizer feedback value if adaptive equalization is used.

The embodiment is not specific to any particular equalizer adaptation method 204, the adaptation need only produce as output either a normalized first feedback tap weight “w” 212 which is sent to module 206, or a combination of an un-normalized first-feedback tap weight hi and reference level value “A” (which may be determined using means known in the art) (see FIG. 7) which is proportional to the received signal value at the data sampling time at the output of summer device 203 such that a normalized feedback weight “w” 212 may be derived from the ratio of h1/A.

Module 206 may perform a phase-prediction adjustment, a measurement based adjustment (e.g., comparing non-equalized to equalized waveforms) or a combination of both. In one embodiment, the phase-prediction algorithm of module 206 computes a time delay, or phase shift, as a function of a normalized first feedback tap weight and a user-settable slope correction parameter k. An appropriate formula for the phase-prediction function is given in formula (15), although other formulas can be used as found appropriate for other specific embodiments. The output of the phase-prediction algorithm is a time-offset, or phase-offset (φ), which is used to advance or delay the clock using a time shift device 207, such as a delay element, which is used by the A/D sampling device 205 to sample the data value.

A time-offset control value or phase prediction adjustment value (φ) is applied to delay element 207, which represents any device or mechanism capable of accurately advancing the relative time position of a data sampling clock.

In another example, module 206 resolves a waveform crossing time of a non equalizer-corrected received waveform, and resolves the waveform-crossing time of an equalizer-corrected received waveform. A timing bias output due to equalization is then estimated as the difference in needed delay between these signals. The timing bias is then employed to compensate signal delays as described above, e.g., it is applied to a device 207 capable of adjusting a timing bias of a sample clock.

The embodiment as described is not intended to be limited to any specific equalizer algorithm 204 or time delay control mechanism 207.

Referring to FIG. 7, an illustrative binary serial data receiver architecture includes a receiver system 300 having a data receiver 324 with an adaptive equalizer 304. In this embodiment, receiver 324 also includes a digital phase locked loop (PLL) 352. A controllable time delay 307 (or time shift 207 FIG. 6) is efficiently added to this architecture by summing an offset between Data Clock rotator 353 and Edge Clock rotator 354 (or mixers). Since this sum is done in the digital domain, it is accurate and incurs very little hardware penalty.

In the data receiver system 300, a phase-locked loop (PLL) 342 creates a reference clock (Ref Clock), which is aligned in phase (or edge transition times) with a received data waveform. Once the receiver's phase-locked loop 342 acquires the timing point of the received data waveform transitions or edges, the timing point to sample the data is set at a fixed offset (e.g., ½ symbol time, or 180 degrees in phase) from the edge timing reference.

The PLL block 342 includes an early-late integrator, which drives a voltage-controlled oscillator to lock to the transitions of the received data signal. The resulting edge clock, which is aligned to the edge positions of the received signal, is shifted in phase by 180 degrees (or ½ data symbol time) to produce a clock for sampling the data values midway within the data symbol time interval.

Analog PLL 342 produces a fixed frequency clock output. The PLL output drives two mixers 353 and 354, or rotators, which have the ability to rotate the PLL output clock from 0 to 360 degrees by adjusting mixer analog control levels I and Q (in-phase and quadrature).

The IQ phase setting, or rotator phase-shift value is determined using a Digital PLL algorithm 352 which processes the received Data/Edge signals to create a sequence of rotator values which keep the rotated edge clock aligned to the transitions of the received data signal. The rotated edge clock is shifted 180 degrees in block 356 by independently adjusting the IQ values for the data clock such that they are 180 degrees out of phase with the edge clock. Digital to analog converters D/A are employed convert digital IQ values to analog values.

Decision-feedback equalizer 304 outputs feedback tap weight h1, and A to predict phase changes in accordance with a phase-prediction timing bias compensation block 320 to provide a phase-offset value φ at the output of a phase prediction adjustment module 306. Equalizer 304 may include an adaptive equalizer, although other equalization methods may be employed.

Application of the phase-offset value (φ) to the data clock creates a feedback loop 318, which normally results in modification of the feedback tap value h1. This effect occurs since the movement of data clock causes the data values to be sampled at a different relative time within a received UI interval, which can change the ISI value at the data sampling instant. In an application where hi is negative, advancing the data clock will cause the h1 value to go further negative (because correlation with the previous data bit increases when the clock is advanced), which in turn causes the clock to advance further if the phase offset value is updated to the delay control element periodically.

The positive-feedback effect of increasing magnitude of h1 (due to increased correlation with previous received data) when the phase offset value is applied to the data clock may be compensated by applying a reduction in the value of the phase offset formula in module 306 as the phase offset increases in value. Specifically, further control over the feedback loop stabilization point when using periodic phase offset updating can be gained by modifying the phase prediction function (f( ))such that it accepts as an argument the current phase offset value (φ).

As an example, the phase offset function f( ) in phase offset block 306 may be modified to decrease in value when the phase offset value (φ) becomes larger. In general, if f(n) is the current value of the phase offset a periodically updated value may be computed according to
f(n+1)=f(h1,A,k,f(n)) (16)

As a specific example, phase prediction formula (15) may be modified as follows:
f(n+1)=h1/((A+k2*f(n))*(P/2.444)*k (17)
where k2 is a scalar constant selected to achieve the desired feedback loop stabilization point.

To avoid running the data clock offset too close to the edge clock in the case of large “h1” values, which may arise in some channels, a hard limit may be imposed on the maximum value of the phase offset, in a preferred embodiment. Specifically, if a computed phase offset value (φ) is larger than a fixed limit, the data/edge phase offset control value is set to the fixed limit rather than the computed phase offset value. A fixed limit in a preferred embodiment may be, e.g., ¾ of the time interval from edge clock to data clock, or e.g., ⅜ of a full symbol period.

All applications of the described timing bias compensation may not require periodic update of the timing offset value. In non-periodic update, a timing offset value is computed using formula (15) or other appropriate function following a convergence of the first feedback tap weight and applied to advance or delay the data clock and never updated again. Other applications may not need dynamic input variables h1 and A, for instance in an example application with a fixed (non-adapted) DFE feedback weight the normalized feedback value is known a-priori and as a result the data clock timing offset can be computed and stored a-priori.

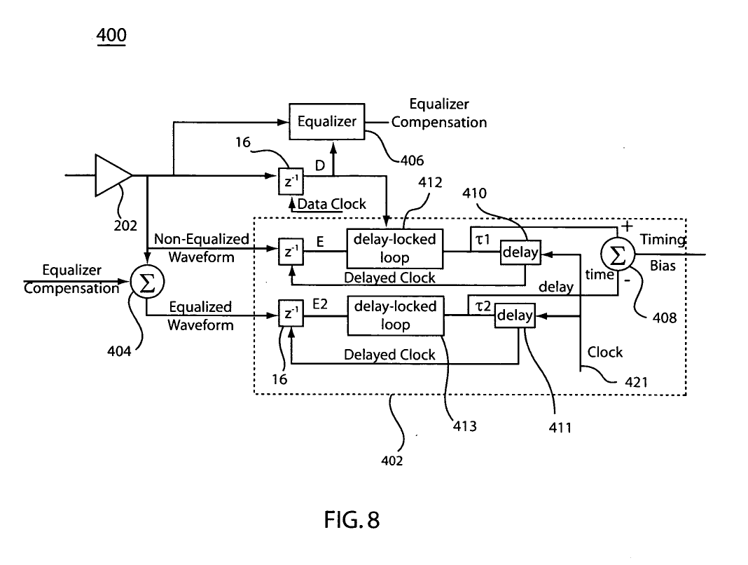

Referring to FIG. 8, with respect to the timing bias waveforms shown in FIG. 4, a measurement-based timing bias determination system similar to the one provided by module 331 of FIG. 7 may include a module 402 capable of determining a waveform crossing time for both an “equalizer-corrected waveform” and a “non-equalizer corrected waveform”, as shown in FIG. 8. As an illustrative example, a system or apparatus 400 may be constructed using an equalizer 406, which may include an adaptive equalizer or any other equalizer. Equalizer outputs an equalization compensation signal or output as described above, e.g., h1 and/or A or any other parameter. A summer 404 receives the equalizer compensation and the non-equalized signal.

Module 402 forms a level comparator/latch with adjustable time delay, forming a delay-locked loop. In this example, a first delay-locked loop 412 is used to resolve the waveform crossing time of a non equalizer-corrected received waveform, and a second delay-locked loop 413 is used to resolve the waveform-crossing time of an equalizer-corrected received waveform. A timing bias output due to equalization is then estimated as the difference in needed delay between first and second delay elements 410 and 411 using summer 408. Delay 410 delays a signal by τ1, and delay 411 delays by τ2. A clock 421 provides synchronization with incoming data. Clock 421 may include a regenerated clock from a PLL system for example. The timing bias is then employed to compensate signal delays as described above, e.g., it is applied to a device capable of adjusting a timing bias of a sample clock.

To lower hardware complexity of an equalizer timing bias compensation system, a timing offset prediction formula as described above with reference to FIG. 7 may be used for determination of timing bias.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for adjusting phase of a sample clock in a data receiver system, comprising the steps of:
determining a time adjustment value as a function of equalizer feedback; and
applying the time adjustment value to a device capable of adjusting a timing bias of a sample clock.

2. The method of claim 1, wherein the time adjustment value includes a predicted phase adjustment.

3. The method of claim 2, further comprising the step of adjusting the predicted phase adjustment value by employing a user programmable parameter.

4. The method of claim 1, wherein the time adjustment value is determined from measurement of a received waveform.

5. The method of claim 1, wherein the equalizer feedback is fixed, or non-adapted, such that a fixed timing offset is applied to the sample clock as a function of the fixed feedback.

6. The method of claim 5, wherein the equalizer is a decision-feedback equalizer and further comprising the step of utilizing a first feedback tap with a fixed normalized feedback weight.

7. The method of claim 1, wherein the equalizer includes an adapted equalizer, and the step of applying comprises applying the timing adjustment value to the sample clock as a function of adapted feedback weights.

8. The method of claim 1, wherein the step of applying the timing adjustment value includes utilizing a first feedback tap with an adapted feedback weight.

9. The method of claim 8, further comprising the step of updating a clock phase value once following convergence of an adapted equalizer tap weight as a function of the adapted feedback weights.

10. The method of claim 8, further comprising the step of updating a clock phase value periodically as a function of a continuously adapted equalizer weight.

11. The method of claim 1, further comprising the step of summing a digital offset value to a data or edge rotator, or phase control value in a digital-phase locked loop clock-and-data recovery system by applying a clock phase adjustment value.

12. The method of claim 1, wherein a clock phase adjustment range includes a fixed range.

13. A program storage device readable by machine, tangibly embodying a program of instructions executable by the machine to perform method steps for adjusting phase of a sample clock in a data receiver system, as recited in claim 1.

14. A phase adjustment apparatus which adjusts a sample clock in a data receiver system as a function of a feedback from an equalizer, comprising:
a time adjustment module that determines a time adjustment value as a function of a equalizer feedback; and
a device capable of adjusting the phase of a sample clock in accordance with the time adjustment value.

15. The apparatus of claim 14, wherein the time adjustment value includes a predicted phase adjustment.

16. The apparatus of claim 15, further comprising a user programmable parameter for adjusting the predicted phase adjustment value.

17. The apparatus of claim 14, wherein the time adjustment value includes a phase advance determined from measurement of a received waveform.

18. The apparatus of claim 14, wherein the equalizer feedback is fixed, or non-adapted, such that a fixed timing adjustment value is applied to the sample clock as a function of the feedback.

19. The apparatus of claim 18, wherein the equalizer includes a decision-feedback equalizer including a first feedback tap with a fixed normalized feedback weight.

20. The apparatus of claim 14, wherein the equalizer includes an adapted equalizer, such that a variable timing adjustment value is applied to the sample clock as a function of adapted feedback weights.

21. The apparatus of claim 14, wherein the equalizer includes a decision-feedback equalizer having a first feedback tap with an adapted feedback weight.

22. The apparatus of claim 14, wherein the apparatus is included in a clock-and-data recovery system.

23. A phase adjustment apparatus which adjusts a sample clock in a data receiver system as a function of a feedback weight of an equalizer, comprising:
an equalizer which adjusts inter-symbol interference added to current data input thereto and outputs at least one equalizer feedback weight;
a time adjustment module coupled to the equalizer to determine a time adjustment value as a function of at least one equalizer feedback weight; and
a device capable of adjusting the phase of the sample clock in accordance with the time adjustment value.

24. The apparatus of claim 23, wherein the time adjustment module includes a predicted phase adjustment module and the time adjustment value include a predicted phase adjustment value.

25. The apparatus of claim 24, wherein the predicted phase adjustment module employs a user programmable parameter to determine the predicted phase adjustment value.

26. The apparatus of claim 23, wherein the time adjustment value is determined from measurement of a received waveform.

27. The apparatus of claim 23, wherein the equalizer includes one of a decision-feedback equalizer, and an adapted equalizer.
